(19) United States
(12) Patent Application Publication
(10) Pub. No.: US 2014/0089696 A1
(43) Pub. Date: Mar. 27, 2014

(54) METHOD FOR CONTROLLING POWER MODE SWITCHING

(71) Applicant: WISTRON CORP., New Taipei City (TW)

(72) Inventor: Yu-Hong Chen, New Taipei City (TW)

(73) Assignee: WISTRON CORP., New Taipei City (TW)

(21) Appl. No.: 13/957,247

(22) Filed: Aug. 1, 2013

(30) Foreign Application Priority Data
Sep. 26, 2012 (TW) 101135227

(51) Int. Cl. G06F 1/32

(52) U.S. Cl. CPC G06F 1/3212
USPC 713/320

(57) ABSTRACT

A method for controlling power mode switching, applied to a computer device, is provided. The computer device includes a power source supplying electrical power to the computer device for operation and is operated in a first power mode. In the method, firstly, a request for switching the computer to a second power mode is received. A power consumption amount corresponding to the second power mode is calculated. A remaining capacity of the power source is obtained. Then, whether the power consumption amount is larger than the remaining capacity is determined. If the power consumption amount is larger than the remaining capacity, a warning indicating that the remaining capacity is not sufficient is sent to an operating system of the computer device and the computer device is not switched to the second power mode.

### CROSS REFERENCE TO RELATED APPLICATIONS

This Application claims priority of Taiwan Patent Application No. 101135227, filed on Sep. 26, 2012, the entirety of which is incorporated by reference herein.

### BACKGROUND OF THE INVENTION

1. Field of the Invention

The invention relates to power modes of a computer device, and more particularly to a control mechanism of switching power modes.

2. Description of the Related Art

As technology develops, clock rate of a processor of a computer device increases and thus the power consumption increases. Therefore, how to effectively perform power management on a computer device, such as a desktop computer or a notebook computer, is an important issue. For example, in a power control device of a notebook computer disclosed in Taiwan Patent Publication No. 590277 (Application No. 092205373), when a user doesn't perform any operation on the notebook computer through a mouse or a keyboard for a long time, the notebook computer is switched to a power saving mode or a sleep mode so as to save power consumption. However, when the user switches power modes, for example, when the user wants to cancel the sleep mode and switch the computer to a normal operation mode, if the remaining battery capacity is not sufficient for the desired power mode the user wants, the battery may be overdischarged, and thereby causing damage to the battery.

### BRIEF SUMMARY OF THE INVENTION

In view of this, the invention provides a method for controlling power mode switching to calculate a power consumption amount of a desired power mode before a power mode switching is performed and then compare the power consumption amount with a remaining capacity of a battery so as to determine whether to perform the power mode switching.

An embodiment of the invention provides a method for controlling power mode switching, applied to a computer device, wherein the computer device comprises a power source supplying electrical power to the computer device for operation, the computer device is operated in a first power mode, and the method comprising: receiving a request for switching the computer device to a second power mode; calculating a power consumption amount corresponding to the second power mode; obtaining a remaining capacity of the power source; determining whether the power consumption amount is larger than the remaining capacity; and if the power consumption amount is larger than the remaining capacity, sending a warning, which indicates that the remaining capacity is not sufficient, to an operating system of the computer device and preventing the computer device from being switched to the second power mode.

Another embodiment of the invention provides a computer program product embodied in a non-transitory computer-readable medium, wherein when the computer program product is loaded into and executed by a computer device, the computer device practices a method for controlling power mode switching, wherein the computer device comprises a power source supplying electrical power to the computer device for operation, the computer device is operated in a first power mode, and the computer program product comprising: a first program code for receiving a request for switching the computer device to a second power mode; a second program code for calculating a power consumption amount corresponding to the second power mode; a third program code for obtaining a remaining capacity of the power source; a fourth program code for determining whether the power consumption amount is larger than the remaining capacity; and a fifth program code for sending a warning, which indicates that the remaining capacity is not sufficient, to an operating system of the computer device and preventing the computer device from being switched to the second power mode if the power consumption amount is larger than the remaining capacity.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 illustrates a flowchart of a method for controlling power mode switching according to an embodiment of the invention;

FIG. 2 illustrates a block diagram of a computer device according to an embodiment of the invention.

### DETAILED DESCRIPTION OF THE INVENTION

This description is made for the purpose of illustrating the general principles of the invention and should not be taken in a limiting sense. In addition, the present disclosure may repeat reference numerals and/or letters in the various examples. This repetition is for the purpose of simplicity and clarity and does not in itself dictate a relationship between the various embodiments and/or configurations discussed. The scope of the invention is best determined by reference to the appended claims.

It is understood that the following disclosure provides many different embodiments, or examples, for implementing different features of the application. Specific examples of components and arrangements are described below to simplify the present disclosure. These are, of course, merely examples and are not intended to be limiting.

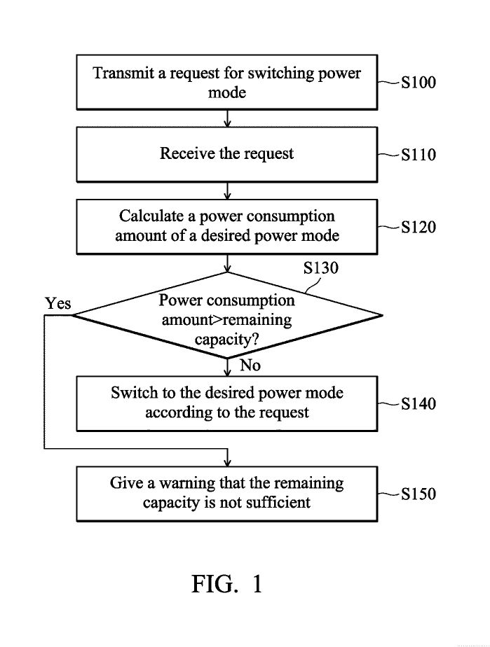

FIG. 1 illustrates a flowchart of a method for controlling power mode switching according to an embodiment of the invention. The method for controlling power mode switching is applied to a computer device, which at least comprises a power source (for example, a rechargeable battery). The computer device can be operated in different power modes, such as a power saving mode, a normal operation mode and so on.

In step S100, firstly, a request for switching power mode is issued. For example, when the computer device is to be switched from the power saving mode to the normal operation mode, a request for switching the computer device to the normal operation mode is issued. Then, in step S110, the request is received. In step S120, a power consumption amount of a desired power mode requested by the request is calculated. For example, after the request for switching the computer device to the normal operation mode is received, a power consumption amount corresponding to the normal operation mode is calculated. Then, in step S130, the calculated power consumption amount is compared with a remaining capacity of the power source to determine whether the power consumption amount is larger than the remaining capacity of the power source. If the power consumption amount is larger than the remaining capacity of the power source (step S130: Yes), that is, the remaining capacity of the power source is not sufficient to supply electrical power to the computer device operated in the desired power mode, a warning signal is issued to warn that the remaining capacity of the power source is not sufficient, and the computer device doesn't perform the power mode switching requested by the request, as shown in step S150. In an example, the warning signal is transmitted to an output device of the computer device in the form of a multimedia file so as to warn a user against having insufficient remaining capacity of the power source. The output device of the computer device can be s a speaker, a display screen or any other output device. The multimedia file can be an audio file, an image, a video file or any other multimedia file. In another example, an operating system (OS) of the computer device receives the warning signal and stores data of the OS after receiving the warning signal so as to avoid data loss due to the unfinished storage caused by insufficient remaining capacity. Alternatively, after the warning signal is received, if the computer device comprises a spare power source, such as a DC power source, the computer device is connected to the spare power source. Therefore, if the power consumption amount corresponding to the desired power mode is larger than the remaining capacity of the power source, the power mode switching requested by the request is not performed, thereby avoiding damage to the power source caused by overdischarge of the power source when the computer is forced to be switched to a power mode that requires power consumption amount larger than the remaining capacity of the power source. On the other hand, if the power consumption amount is not larger than the remaining capacity of the power source (step S130: NO), the computer device is switched to the desired power mode requested by the request, such as switching the computer device from the power saving mode to the normal operation mode.

It is to be noted that the power modes are not limited to the power saving mode and the normal operation mode in the invention. The power modes may further comprise other power modes including predefined or user-defined power modes, such as a sleep mode, a high performance mode, and so on.

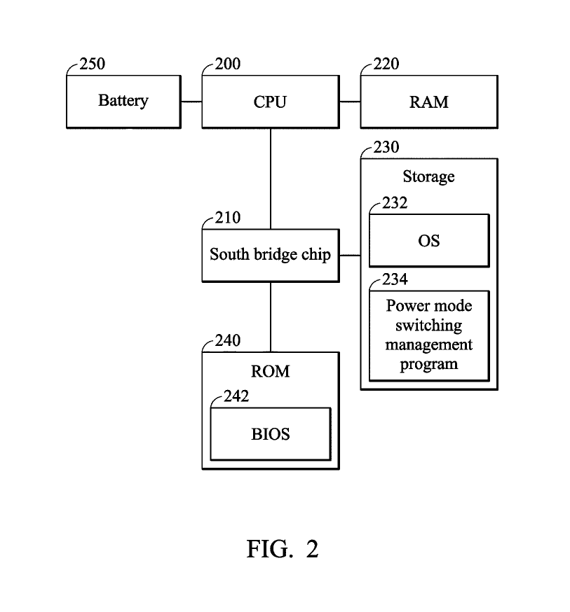

FIG. 2 illustrates a block diagram of a computer device according to an embodiment of the invention. The computer device comprises a central processing unit (CPU) 200, a south bridge chip 210, a random access memory (RAM) 220, a storage 230, a read only memory (ROM) 240 and a battery 250. The storage 230 may be a hard disk drive. The ROM 240 stores a basic input output system (BIOS) 232. The storage 230 stores an operating system (OS) 232. The method for controlling power mode switching described above may take the form of a program code, such as a power mode switching management program 234, embodied in the storage 230. When the power mode switching management program 234 is loaded into and executed by the CPU 200 of the computer device, the computer device performs the method for controlling power mode switching described above. The method for controlling power mode switching described above is explained in the following with references made to FIG. 2.

When the computer device is turned on, the CPU 200 loads the BIOS 242 into the RAM 220 from the ROM 240 via the south bridge chip 210 and executes the BIOS 242 to detect each hardware component and communicate with each hardware component. Then, the CPU 200 loads the OS 232 from the storage 230 into the RAM 220 via the south bridge chip 210 and executes the OS 232 to control and process each hardware and software. The power mode switching management program 234 is loaded into the CPU 200 from the storage 230 and is executed by the CPU 200. When the user issues a power mode switching request for switching the computer device to another power mode through, for example, a user interface of the power mode switching management program 234 or a hotkey, the power mode switching management program 234 receives the power mode switching request. After receiving the power mode switching request, the power mode switching management program 234 calls the BIOS 242 and calculates a power consumption amount corresponding to a desired power mode requested by the power mode switching request (that is, the another power mode described above). For example, if the computer device is ACPI (Advanced Configuration and Power Interface) compatible, power consumption amounts required by all components of the computer device in the desired power mode are calculated according to global system states G0˜Gn, device power states D0˜Dn, processor power states C0˜Cn and device and processor performance states defined in the ACPI standard, and then the power consumption amounts required by all components of the computer device are summed to generate the power consumption amount corresponding to the desired power mode.

Then, the power mode switching management program 234 calls the BIOS 242 to obtain a current remaining capacity of the battery 250. The power mode switching management program 234 compares the power consumption amount corresponding to the desired power mode with the remaining capacity of the battery 250. If the power consumption amount corresponding to the desired power mode is larger than the remaining capacity of the battery 250, that is, the remaining capacity of the battery 250 is not sufficient for the desired power mode, the power mode switching management program 234 transmits a warning signal to warn that the remaining capacity is not sufficient and the computer device is prevented from being switched to the desired power mode. In an example, the power mode switching management program 234 transmits the warning signal to an output device of the computer device in the form of a multimedia file so as to warn the user against having insufficient remaining capacity. The output device of the computer device can be s a speaker, a display screen or any other output device. The multimedia file can be an audio file, an image, a video file or any other multimedia file. In another example, the power mode switching management program 234 transmits the warning signal to the OS. After the OS receives the warning signal, the CPU 200 stores data of the OS2 and/or other data so as to avoid data loss due to the unfinished storage caused by insufficient remaining capacity. Alternatively, after the warning signal is received, if the computer device comprises a spare power source, such as a DC power source, the computer device is connected to the spare power source. On the other hand, if the power consumption is not larger than the remaining capacity, the power mode switching management program 234 performs the power mode switching according to the power mode switching request, such as switching the computer device from the power saving mode to the normal operation mode.

As described above, according to the embodiments of the invention, after a power mode switching request is issued, a computer device may firstly calculate a power consumption amount of a desired power mode requested by the power mode switching request instead of immediately performing a power mode switching according to the power mode switching request. Then, the power consumption amount is compared with a remaining capacity of a power source of the computer device, and whether the computer device is switched to the desired power mode is determined according to the comparison result. If the power consumption amount is larger than the remaining capacity, the power mode switching is not performed to avoid damage to the power source caused by overdischarge of the power source when the computer is forced to be switched to the desired power mode that requires power consumption amount larger than the remaining capacity of the power source.

Methods and systems of the present disclosure, or certain aspects or portions of embodiments thereof, may take the form of a program code (i.e., instructions) embodied in media, such as floppy diskettes, CD-ROMS, hard drives, firmware, or any other non-transitory machine-readable storage medium, wherein, when the program code is loaded into and executed by a machine, such as a computer, the machine becomes an apparatus for practicing embodiments of the disclosure. The methods and apparatus of the present disclosure may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing and embodiment of the disclosure. When implemented on a general-purpose processor, the program code combines with the processor to provide a unique apparatus that operates analogously to specific logic circuits.

An embodiment of the invention provides a computer program product embodied in a non-transitory computer-readable medium, wherein when the computer program product is loaded into and executed by a computer device, the computer device practices a method for controlling power mode switching, wherein the computer device comprises a power source supplying electrical power to the computer device for operation, the computer device is operated in a first power mode, and the computer program product comprises: a first program code for receiving a request for switching the computer device to a second power mode; a second program code for calculating a power consumption amount corresponding to the second power mode; a third program code for obtaining a remaining capacity of the power source; a fourth program code for determining whether the power consumption amount is larger than the remaining capacity; and a fifth program code for sending a warning, which indicates that the remaining capacity is not sufficient, to an operating system of the computer device and preventing the computer device from being switched to the second power mode if the power consumption amount is larger than the remaining capacity. The computer program product further comprises a sixth program code for switching the computer device to the second power mode if the consuming power is not larger than the remaining power. The computer program product further comprises a seventh program code for storing data of the operating system when the operating system receives the warning.

While the invention has been described by ways of examples and in terms of preferred embodiments, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for controlling power mode switching, applied to a computer device, wherein the computer device comprises a power source supplying electrical power to the computer device for operation, the computer device is operated in a first power mode, and the method comprising:
receiving a request for switching the computer device to a second power mode;
calculating a power consumption amount corresponding to the second power mode;
obtaining a remaining capacity of the power source;
determining whether the power consumption amount is larger than the remaining capacity; and
when the power consumption amount is larger than the remaining capacity, sending a warning, which indicates that the remaining capacity is not sufficient, to an operating system of the computer device and preventing the computer device from being switched to the second power mode.

2. The method as claimed in claim 1, further comprising:
when the consuming power is not larger than the remaining power, switching the computer device to the second power mode.

3. The method as claimed in claim 1, further comprising:
when the operating system receives the warning, storing data of the operating system.

4. A computer program product embodied in a non-transitory computer-readable medium, wherein when the computer program product is loaded into and executed by a computer device, the computer device practices a method for controlling power mode switching, wherein the computer device comprises a power source supplying electrical power to the computer device for operation, the computer device is operated in a first power mode, and the computer program product comprising:
a first program code for receiving a request for switching the computer to a second power mode;
a second program code for calculating a power consumption amount corresponding to the second power mode;
a third program code for obtaining a remaining capacity of the power source;
a fourth program code for determining whether the power consumption amount is larger than the remaining capacity; and
a fifth program code for sending a warning, which indicates that the remaining capacity is not sufficient, to an operating system of the computer device and preventing the computer device from being switched to the second power mode if the power consumption amount is larger than the remaining capacity.

5. The computer program product as claimed in claim 4, further comprising:
a sixth program code for switching the computer device to the second power mode if the consuming power is not larger than the remaining power.

6. The computer program product as claimed in claim 4, further comprising:
a seventh program code for storing data of the operating system when the operating system receives the warning.
